(19) United States
(12) Patent Application Publication
(10) Pub. No.: US 2020/0165164 A1
(43) Pub. Date: May 28, 2020

(54) CEMENT SLURRIES, CURED CEMENT AND METHODS OF MAKING AND USE THEREOF

(71) Applicant: Saudi Arabian Oil Company, Dhahran (SA)

(72) Inventor: Peter J. Boul, Houston, TX (US)

(73) Assignee: Saudi Arabian Oil Company, Dhahran (SA)

(21) Appl. No.: 16/693,588

(22) Filed: Nov. 25, 2019

Related U.S. Application Data
(60) Provisional application No. 62/771,369, filed on Nov. 26, 2018.

(51) Int. Cl. C04B 24/26; C04B 14/30; C04B 24/00; C04B 14/04; C04B 7/02

(52) U.S. Cl. CPC C04B 24/2641; C04B 14/30; C04B 7/02; C04B 14/04; C04B 24/003

(57) ABSTRACT

Cement slurries, cured cements, and methods of making cured cement and methods of using cement slurries are provided. The cement slurries have, among other attributes, an extended thickening time, leading to improved retardation, flowability, and pumpability and may be used, for instance, in the oil and gas drilling industry. The cement slurry comprises water, a cement precursor material, acrylic acid copolymer, zinc oxide, and a phosphonic acid-based thickener.

### CROSS-REFERENCE TO RELATED APPLICATIONS

This application claims priority to and incorporates by reference U.S. Provisional Application Ser. No. 62/771,369, filed Nov. 26, 2018.

### TECHNICAL FIELD

Embodiments of the present disclosure generally relate to cement slurries and methods of making and using cement slurries and to cure cements and methods of making cured cement. Specifically, embodiments of the present disclosure relate to cement slurries and cured cements that have at least two retarder additives and methods of making and using cement slurries and cured cements having at least two retarder additives.

### BACKGROUND

Cement slurries are used in the oil and gas industries, such as for cementing in oil and gas wells. Primary, remedial, squeeze, and plug cementing techniques can be used to place cement sheaths in an annulus between casing and well formations, for well repairs, well stability, and for well abandonment (sealing an old well to eliminate safety hazards). These cement slurries must be able to consistently perform over a wide range of temperatures and pressures, in the presence of certain corrosive chemical species, and under challenging mechanical conditions, as oil and gas wells can be located in a multitude of diverse locations. A cement slurry may be used in conditions less than 32° F. in freezing permafrost zones, and in temperatures exceeding 400° F. in geothermal wells and must be able to properly set under an assortment of conditions.

Proper hardening of a cement slurry can be vital to the strength and performance properties of the cured cement composition. However, conventional cement solutions may gel quickly due to the fast thickening time of the slurry, leading to poor flowability and creating concerns when handling or pumping the cement, as uniform placement of the slurry can be quite difficult. Moreover, cement slurries are often incompatible with other fluids that may be present in the casing or the wellbore wall, such as drilling fluids, and prolonged contact could cause the cement slurry to gel, preventing proper placement and removal of the cement. Cement slurries with an extended thickening time allow for more accurate and precise placement of the cement.

### SUMMARY

Accordingly, there is an ongoing need for cement slurries having good flowability and pumpability with improved retardation and an extended thickening time to avoid gelation issues. Furthermore, there is a need for cement slurries capable of a right angle set at temperatures exceeding 350° F. The present embodiments address these needs by providing cement slurries and methods of making and using cement slurries that have improved rheology and retardation.

In one embodiment, a cement slurry is provided comprising water, a cement precursor material, acrylic acid copolymer, zinc oxide, and a phosphonic acid-based thickener.

Additional features and advantages of the described embodiments will be set forth in the detailed description which follows, and in part will be readily apparent to those skilled in the art from that description or recognized by practicing the described embodiments, including the detailed description which follows as well as the claims.

### DETAILED DESCRIPTION

As used throughout this disclosure, the term “cement slurry” refers to a composition comprising a cement precursor that is mixed with at least water to form cement. The cement slurry may contain calcined alumina (Al₂O₃), silica (SiO₂), calcium oxide (CaO, also known as lime), iron oxide (Fe₂O₃), magnesium oxide (MgO), clay, sand, gravel, and mixtures thereof.

As used throughout this disclosure, the term “consistency” refers to a rheological property of matter related to the cohesion of the individual particles of a given material, its ability to deform and its resistance to flow. The consistency of cement slurries is determined by thickening time tests in accordance with API Recommended Practice 10B and is expressed in Bearden units of consistency (Bc), a dimensionless quantity with no direction conversion factor to more common units of viscosity. The Bearden units of consistency is measured on a scale from 1 to 100 where, conventionally, difficult pumping is thought to begin at 50 Bc, and cement is completely set at 100 Bc.

As used throughout this disclosure, the term “curing” refers to providing adequate moisture, temperature and time to allow the concrete to achieve the desired properties (such as hardness) for its intended use through one or more reactions between the water and the cement precursor material.

As used throughout this disclosure, the term “drying” refers to merely allowing the cement to achieve a moisture condition appropriate for its intended use, which may only involve physical state changes, as opposed to chemical reactions.

As used throughout this disclosure, the term “point of departure” refers to the beginning of thickening of a cement slurry during the thickening-time test, and is often abbreviated as POD. For some cement slurries, the POD is used as the thickening time.

As used throughout this disclosure, the term “retarder” refers to a chemical agent used to increase the thickening time of cement slurries to enable proper placement. The need for cement retardation increases with depth due to the greater time required to complete the cementing operation and the effect of increased temperature on the cement-setting process.

As used throughout this disclosure, the term “right angle set” refers to the characteristic of a cement slurry whose consistency changes from the point of departure, or from 30 Bc to 100 Bc, in a short time. The term refers to the characteristic 90-degree bend in a plot of cement consistency versus time.

As used throughout this disclosure, the term “subsurface formation” refers to a body of rock that is sufficiently distinctive and continuous from the surrounding rock bodies that the body of rock can be mapped as a distinct entity. A subsurface formation is, therefore, sufficiently homogenous to form a single identifiable unit containing similar rheological properties throughout the subsurface formation, including, but not limited to, porosity and permeability. A subsurface formation is the fundamental unit of lithostratigraphy.

As used throughout this disclosure, the term “thickening time” refers to a measurement of the time during which a cement slurry remains in a fluid state and is capable of being pumped. Thickening time is assessed under downhole conditions using a pressurized consistometer that plots the viscosity of a slurry over time under the anticipated temperature and pressure conditions. The end of the thickening time is conventionally about 50 or 70 Bc.

As used throughout this disclosure, the term “wellbore” refers to the drilled hole or borehole, including the openhole or uncased portion of the well. Borehole may refer to the inside diameter of the wellbore wall, which is the rock face that bounds the drilled hole.

Embodiments of the present disclosure relate to cement slurries with improved retardation and without gelation issues. Embodiments of the present disclosure also relate to methods of producing and using cement slurries, in some particular embodiments, for use in the oil and gas industries.

Embodiments of the present disclosure relate to cement slurries with improved retardation and without gelation issues. The cement slurries of the present disclosure may be used in the oil and gas drilling industries, such as for cementing in oil and gas wells. Oil and gas wells may be formed in subsurface formations. The wellbore may serve to connect natural resources, such as petrochemical products, to a ground level surface. In some embodiments, a wellbore may be formed in the subsurface formation, which may be formed by a drilling procedure. To drill a subterranean well or wellbore, a drill string including a drill bit and drill collars to weight the drill bit is inserted into a predrilled hole and rotated to cut into the rock at the bottom of the hole, producing rock cuttings. Commonly, drilling fluid may be utilized during the drilling process. To remove the rock cuttings from the bottom of the wellbore, drilling fluid is pumped down through the drill string to the drill bit. The drilling fluid cools the drill bit and lifts the rock cuttings away from the drill bit and carries the rock cuttings upwards as the drilling fluid is recirculated back to the surface.

In some instances, a casing may be inserted into the wellbore. The casing may be a pipe or other tubular structure which has a diameter less than that of the wellbore. Generally, the casing may be lowered into the wellbore such that the bottom of the casing reaches to a region near the bottom of the wellbore. In some embodiments, the casing may be cemented by inserting a cement slurry into the annulus region between the outer edge of the casing and the edge of the wellbore (the surface of the subsurface formation). The cement slurry may be inserted into the annular region by pumping the cement slurry into the interior portion of the casing, to the bottom of the casing, around the bottom of the casing, into the annular region, or a combination of some or all of these. The cement slurry may displace the drilling fluid, pushing it to the top of the well. In some embodiments, a spacer fluid may be used as a buffer between the cement slurry and the drilling fluid by displacing and removing the drilling fluid before the cement slurry is pumped into the well to prevent contact between the drilling fluid and the cement slurry. Following the insertion of an appropriate amount of cement slurry into the interior region of the casing, in some embodiments, a displacement fluid may be utilized to push the cement slurry out of the interior region of the casing and into the annular region. This displacement may cause the entirety of the spacer fluid and drilling fluid to be removed from the annular region, out the top of the wellbore. The cement slurry may then be cured or otherwise allowed to harden.

To ensure the stability and safety of a well, it is important that the cement slurry properly harden into cured cement. If the cement slurry is not evenly placed or fluid is lost from the cement slurry before curing, the cement slurry may not evenly harden into a cured cement. Therefore, the viscosity, flowability, and thickening time of a cement slurry are important properties to ensure proper placement. Specifically, thickening time may be retarded by the use of retarder additives, creating more time for optimal placement of the cement before setting. Similarly, reducing fluid loss from the cement slurry ensures uniform hardening, as curing often involves water-based reactions with the cement slurry. Too much or too little water affects the hardness and, thus, the quality of the cured cement produced.

A number of conditions may impact the fluid loss of a cement slurry. For instance, water may be drawn from the slurry into the permeable subsurface formation, particularly if pumping ceases and the slurry becomes static without hardening. Water may also be lost due to displacement as the cement slurry is passed through constrictions, such as the tight clearance between a casing and an annulus, which may “squeeze” water from the slurry. Adverse weather and soil conditions may additionally impact the amount of water present in the cement slurry. As such, control of fluid loss of the cement slurry may allow for a more uniform and stronger cured cement.

The present disclosure provides cement slurries which may have, among other attributes, improved rheology and reduced fluid loss to address these concerns. The cement slurry of the present disclosure includes water, a cement precursor material, acrylic acid copolymer, zinc oxide, and a phosphonic acid-based thickener. Without being bound by any particular theory, use of the acrylic acid copolymer along with the zinc oxide in some embodiments may provide extended thickening time of the cement slurry to allow for easier processing, flowability, and handling of the cement slurry in various applications. Moreover, extending the thickening time will reduce the pumping pressure needed to pump and place cement into the well.

The cement precursor material may be any suitable material which, when mixed with water, can be cured into a cement. The cement precursor material may be hydraulic or non-hydraulic. A hydraulic cement precursor material refers to a mixture of limestone, clay and gypsum burned together under extreme temperatures that may begin to harden instantly or within a few minutes while in contact with water. A non-hydraulic cement precursor material refers to a mixture of lime, gypsum, plasters and oxychloride. A non-hydraulic cement precursor may take longer to harden or may require drying conditions for proper strengthening, but often is more economically feasible. A hydraulic or non-hydraulic cement precursor material may be chosen based on the desired application of the cement slurry of the present disclosure. In some embodiments, the cement precursor material may be Portland cement precursor, such as Class G Portland Cement. Portland cement precursor is a hydraulic cement precursor (cement precursor material that not only hardens by reacting with water but also forms a water-resistant product) produced by pulverizing clinkers, which contain hydraulic calcium silicates and one or more of the forms of calcium sulfate as an inter-ground addition. In other embodiments, the cement precursor material may be Saudi cement precursor, which is a combination of Portland cement precursor and crystalline silica. Crystalline silica is also known as quartz.

The cement precursor material may include one or more of calcium hydroxide, silicates, oxides, belite (Ca₂SiO₅), alite (Ca₃SiO₄), tricalcium aluminate (Ca₃Al₂O₆), tetracalcium aluminoferrite (Ca₄Al₂Fe₂O₁₀), brownmilleriate (4CaO.Al₂O₃.Fe₂O₃), gypsum (CaSO₄.2H₂O) sodium oxide, potassium oxide, limestone, lime (calcium oxide), hexavalent chromium, calcium aluminate, silica sand, silica flour, hematite, manganese tetroxide, other similar compounds, and combinations of these. The cement precursor material may include Portland cement, siliceous fly ash, calcareous fly ash, slag cement, silica fume, quartz, any known cement precursor material or combinations of any of these. Silica flour is a finely ground crystalline silica with a molecular formula of SiO₂ and with a grain size ranging from 1 to 500 microns, from 10 to 500 microns, from 10 to 100 microns, from 10 to 80 microns, from 10 to 50 microns, from 10 to 20 microns, from 20 to 100 microns, from 20 to 80 microns, from 20 to 50 microns, from 50 to 100 microns, from 50 to 80 microns, or from 80 to 100 microns.

The cement slurry may include Saudi Class G cement. Saudi Class G cement may include from 60 to 100 weight percent (wt. %), from 60 to 99 wt. %, from 60 to 98 wt. %, from 60 to 97 wt. %, from 60 to 96 wt. %, from 60 to 95 wt. %, from 60 to 90 wt. %, from 60 to 80 wt. %, from 60 to 70 wt. %, from 70 to 100 wt. %, from 70 to 99 wt. %, from 70 to 98 wt. %, from 70 to 97 wt. %, from 70 to 96 wt. %, from 70 to 95 wt. %, from 70 to 90 wt. %, from 70 to 80 wt. %, from 80 to 100 wt. %, from 80 to 99 wt. %, from 80 to 98 wt. %, from 80 to 97 wt. %, from 80 to 96 wt. %, from 80 to 95 wt. %, from 80 to 90 wt. %, from 90 to 100 wt. %, from 90 to 99 wt. %, from 90 to 98 wt. %, from 90 to 97 wt. %, from 90 to 96 wt. %, from 90 to 95 wt. %, from 95 to 100 wt. %, from 95 to 99 wt. %, from 95 to 98 wt. %, from 95 to 97 wt. %, from 95 to 96 wt. %, from 96 to 100 wt. %, from 96 to 99 wt. %, from 96 to 98 wt. %, from 96 to 97 wt. %, from 97 to 100 wt. %, from 97 to 99 wt. %, from 97 to 98 wt. %, from 98 to 100 wt. %, from 98 to 99 wt. %, or from 99 to 100 wt. % Portland cement. Saudi Class G cement may include less than 40 wt. %, less than 30 wt. %, less than 20 wt. %, less than 10 wt. %, less than 5 wt. %, less than 4 wt. %, less than 3 wt. %, less than 2 wt. %, or less than 1 wt. % crystalline silica, or quartz. Saudi Class G cement may have a pH of greater than 7, of from 8 to 14, of from 10 to 13, of from 11 to 13, of from 12 to 13, or of 12.4. Saudi Class G cement may have a bulk density at 20° C. of from 70 to 120 pounds per cubic feet (lb/ft³), of from 80 to 110 lb/ft³, of from 90 to 100 lb/ft³, or of 94 lb/ft³. Saudi Class G cement may have a solubility in water of from 0.1 to 2 grams per 100 milliliters (g/100 ml), of from 0.1 to 1 g/100 ml, of from 0.1 to 0.8 g/100 ml, of from 0.1 to 0.5 g/100 ml, of from 0.2 to 2 g/100 ml, of from 0.2 to 1 g/100 ml, of from 0.2 to 0.8 g/100 ml, of from 0.2 to 0.5 g/100 ml, of from 0.4 to 2 g/100 ml, of from 0.4 to 1 g/100 ml, of from 0.4 to 0.8 g/100 ml, of from 0.4 to 0.5 g/100 ml, of from 0.5 to 2 g/100 ml, of from 0.5 to 1 g/100 ml, of from 0.5 to 0.8 g/100 ml, or of 0.5 g/100 ml.

Water may be added to the cement precursor material to produce the slurry. The water may be distilled water, deionized water, or tap water. In some embodiments, the water may contain additives or contaminants. For instance, the water may include freshwater or seawater, natural or synthetic brine, formation water, or salt water. In some embodiments, salt or other organic compounds may be incorporated into the water to control certain properties of the water, and thus the cement slurry, such as density. Without being bound by any particular theory, increasing the saturation of water by increasing the salt concentration or the level of other organic compounds in the water may increase the density of the water, and thus, the cement slurry. Suitable salts may include, but are not limited to, alkali metal chlorides, hydroxides, or carboxylates. In some embodiments, suitable salts may include sodium, calcium, cesium, zinc, aluminum, magnesium, potassium, strontium, silicon, lithium, chlorides, bromides, carbonates, iodides, chlorates, bromates, formates, nitrates, sulfates, phosphates, oxides, fluorides, and combinations of these.

In some embodiments, the cement slurry may contain from 10 wt. % to 70 wt. % by weight of cement precursor (BWOC) water. In some embodiments, the cement slurry may contain from 10 wt. % to 40 wt. %, from 10 wt. % to 30 wt. %, from 10 wt. % to 20 wt. %, from 20 wt. % to 40 wt. %, from 25 wt. % to 35 wt. %, or from 20 wt. % to 30 wt. % BWOC water. The cement slurry may contain 30 wt. % BWOC water.

Along with the cement precursor material and water, the cement slurry includes acrylic acid copolymer and zinc oxide. The acrylic acid copolymer and the zinc oxide function as retarder additives, extending the thickening time of the cement slurry. The acrylic acid copolymer may be made from 2-acrylamido-2-methylpropane sulfonic acid (AMPS) or AMPS-copolymers, including lattices of AMPS-copolymers. The acrylic acid copolymer may have a molecular weight of from 100 to 300 grams per mole (g/mol), 125 to 300 g/mol, 150 to 300 g/mol, 175 to 300 g/mol, 200 to 300 g/mol, 225 to 300 g/mol, 250 to 300 g/mol, 100 to 250 g/mol, 125 to 250 g/mol, 150 to 250 g/mol, 175 to 250 g/mol, 200 to 250 g/mol, 225 to 250 g/mol, 100 to 225 g/mol, 125 to 225 g/mol, 150 to 225 g/mol, 175 to 225 g/mol, 200 to 225 g/mol, 100 to 200 g/mol, 125 to 200 g/mol, 150 to 200 g/mol, 175 to 200 g/mol, 100 to 175 g/mol, 100 to 150 g/mol, 100 to 125 g/mol, 100 to 150 g/mol, 125 to 150 g/mol, or 100 to 125 g/mol. The acrylic acid copolymer may have a molecular weight of 207 g/mol.

The cement slurry may include from 0.1 to 10 wt. %, from 0.1 to 8 wt. %, from 0.1 to 5 wt. %, from 0.1 to 3 wt. %, from 0.1 to 2 wt. %, from 0.1 to 1.5 wt. %, from 0.1 to 1 wt. %, from 0.1 to 0.5 wt. %, from 0.1 to 0.4 wt. %, from 0.4 to 10 wt. %, from 0.4 to 8 wt. %, from 0.4 to 5 wt. %, from 0.4 to 3 wt. %, from 0.4 to 2 wt. %, from 0.4 to 1.5 wt. %, from 0.4 to 1 wt. %, from 0.4 to 0.5 wt. %, from 0.5 to 10 wt. %, from 0.5 to 8 wt. %, from 0.5 to 5 wt. %, from 0.5 to 3 wt. %, from 0.5 to 2 wt. %, from 0.5 to 1.5 wt. %, from 0.5 to 1.2 wt. %, from 0.5 to 0.8 wt. %, from 0.8 to 1.2 wt. %, from 0.8 to 1 wt. %, from 1 to 1.2 wt. %, from 0.9 to 1.1 wt. %, from 0.9 to 1 wt. %, from 0.5 to 1 wt. %, from 1 to 10 wt. %, from 1 to 8 wt. %, from 1 to 5 wt. %, from 1 to 3 wt. %, from 1 to 2 wt. %, from 1 to 1.5 wt. %, from 1.5 to 10 wt. %, from 1.5 to 8 wt. %, from 1.5 to 5 wt. %, from 1.5 to 3 wt. %, from 1.5 to 2 wt. %, from 2 to 10 wt. %, from 2 to 8 wt. %, from 2 to 5 wt. %, from 2 to 3 wt. %, from 3 to 10 wt. %, from 3 to 8 wt. %, from 3 to 5 wt. %, from 5 to 8 wt. %, from 5 to 10 wt. %, or from 8 to 10 wt. % BWOC acrylic acid copolymer. The cement slurry may include 0.94 wt. % BWOC acrylic acid copolymer.

Zinc oxide is an inorganic compound with the molecular formula ZnO. Zinc oxide may have a molecular weight of 81.379 g/mol. The cement slurry may include from 0.1 to 10 wt. %, from 0.1 to 5 wt. %, from 0.1 to 2 wt. %, from 0.1 to 1 wt. %, from 0.1 to 0.8 wt. %, from 0.1 to 0.6 wt. %, from 0.1 to 0.4 wt. %, from 0.1 to 0.3 wt. %, from 0.1 to 0.2 wt. %, from 0.2 to 10 wt. %, from 0.2 to 5 wt. %, from 0.2 to 2 wt. %, from 0.2 to 1 wt. %, from 0.2 to 0.8 wt. %, from 0.2 to 0.6 wt. %, from 0.2 to 0.4 wt. %, from 0.2 to 0.3 wt. %, from 0.3 to 10 wt. %, from 0.3 to 5 wt. %, from 0.3 to 2 wt. %, from 0.3 to 1 wt. %, from 0.3 to 0.8 wt. %, from 0.3 to 0.6 wt. %, from 0.3 to 0.4 wt. %, from 0.4 to 10 wt. %, from 0.4 to 5 wt. %, from 0.4 to 2 wt. %, from 0.4 to 1 wt. %, from 0.4 to 0.8 wt. %, from 0.4 to 0.6 wt. %, from 0.6 to 10 wt. %, from 0.6 to 5 wt. %, from 0.6 to 2 wt. %, from 0.6 to 1 wt. %, from 0.6 to 0.8 wt. %, from 0.8 to 10 wt. %, from 0.8 to 5 wt. %, from 0.8 to 2 wt. %, from 0.8 to 1 wt. %, from 1 to 10 wt. %, from 1 to 5 wt. %, from 1 to 2 wt. %, from 2 to 10 wt. %, from 2 to 5 wt. %, or from 5 to 10 wt. % BWOC zinc oxide. The cement slurry may include 0.3 wt. % BWOC zinc oxide.

As stated previously, the cement slurry comprises a phosphonic acid-based thickener. A phosphonic acid, or phosphonate, is an organophosphorus compound containing C—PO(OH)₂ or C—PO(OR)₂ groups. This the phosphonic acid-based thickener may include at least one of diethylenetriamine pentamethylphosphonic acid (DTPMP) or nitrilotris(methylene) triphosphonic acid (NTMP). DTPMP has a molecular formula of C₉H₂₈N₃O₁₅P₅. NTMP is synonymous with aminotris(methylenephosphonic acid), or ATMP. NTMP has a molecular formula of N(CH₂PO₃H₂)₃.

The cement slurry may include from 0.1 to 10 wt. %, from 0.1 to 8 wt. %, from 0.1 to 5 wt. %, from 0.1 to 3 wt. %, from 0.1 to 2 wt. %, from 0.1 to 1.5 wt. %, from 0.1 to 1 wt. %, from 0.1 to 0.5 wt. %, from 0.1 to 0.4 wt. %, from 0.4 to 10 wt. %, from 0.4 to 8 wt. %, from 0.4 to 5 wt. %, from 0.4 to 3 wt. %, from 0.4 to 2 wt. %, from 0.4 to 1.5 wt. %, from 0.4 to 1 wt. %, from 0.4 to 0.5 wt. %, from 0.5 to 10 wt. %, from 0.5 to 8 wt. %, from 0.5 to 5 wt. %, from 0.5 to 3 wt. %, from 0.5 to 2 wt. %, from 0.5 to 1.5 wt. %, from 0.5 to 1 wt. %, from 0.5 to 1.2 wt. %, from 0.5 to 0.8 wt. %, from 0.8 to 1.2 wt. %, from 0.8 to 1 wt. %, from 1 to 1.2 wt. %, from 0.9 to 1.1 wt. %, from 0.9 to 1 wt. %, from 1 to 10 wt. %, from 1 to 8 wt. %, from 1 to 5 wt. %, from 1 to 3 wt. %, from 1 to 2 wt. %, from 1 to 1.5 wt. %, from 1.5 to 10 wt. %, from 1.5 to 8 wt. %, from 1.5 to 5 wt. %, from 1.5 to 3 wt. %, from 1.5 to 2 wt. %, from 2 to 10 wt. %, from 2 to 8 wt. %, from 2 to 5 wt. %, from 2 to 3 wt. %, from 3 to 10 wt. %, from 3 to 8 wt. %, from 3 to 5 wt. %, from 5 to 8 wt. %, from 5 to 10 wt. %, or from 8 to 10 wt. % BWOC DTPMP. The cement slurry may include 0.94 wt. % BWOC DTPMP.

The cement slurry may include from 0.1 to 10 wt. %, from 0.1 to 8 wt. %, from 0.1 to 5 wt. %, from 0.1 to 3 wt. %, from 0.1 to 2 wt. %, from 0.1 to 1.5 wt. %, from 0.1 to 1 wt. %, from 0.1 to 0.5 wt. %, from 0.1 to 0.4 wt. %, from 0.4 to 10 wt. %, from 0.4 to 8 wt. %, from 0.4 to 5 wt. %, from 0.4 to 3 wt. %, from 0.4 to 2 wt. %, from 0.4 to 1.5 wt. %, from 0.4 to 1 wt. %, from 0.4 to 0.5 wt. %, from 0.5 to 10 wt. %, from 0.5 to 8 wt. %, from 0.5 to 5 wt. %, from 0.5 to 3 wt. %, from 0.5 to 2 wt. %, from 0.5 to 1.5 wt. %, from 0.5 to 1 wt. %, from 0.5 to 1.2 wt. %, from 0.5 to 0.8 wt. %, from 0.8 to 1.2 wt. %, from 0.8 to 1 wt. %, from 1 to 1.2 wt. %, from 0.9 to 1.1 wt. %, from 0.9 to 1 wt. %, from 1 to 10 wt. %, from 1 to 8 wt. %, from 1 to 5 wt. %, from 1 to 3 wt. %, from 1 to 2 wt. %, from 1 to 1.5 wt. %, from 1.5 to 10 wt. %, from 1.5 to 8 wt. %, from 1.5 to 5 wt. %, from 1.5 to 3 wt. %, from 1.5 to 2 wt. %, from 2 to 10 wt. %, from 2 to 8 wt. %, from 2 to 5 wt. %, from 2 to 3 wt. %, from 3 to 10 wt. %, from 3 to 8 wt. %, from 3 to 5 wt. %, from 5 to 8 wt. %, from 5 to 10 wt. %, or from 8 to 10 wt. % BWOC NTMP. The cement slurry may include 0.94 wt. % BWOC NTMP.

In some embodiments, the cement slurry may contain at least one additive other than acrylic acid copolymer, zinc oxide, and DTPMP. As non-limiting examples, suitable additives may include accelerators, retarders, extenders, weighting agents, fluid loss control agents, lost circulation control agents, surfactants, antifoaming agents, elastomers, fibers, or combinations of these.

In some embodiments, the cement slurry may contain from 0.1 to 10 wt. % BWOC of the one or more additives based on the total weight of the cement slurry. For instance, the cement slurry may contain from 0.1 to 8 wt. % BWOC of the one or more additives, from 0.1 to 5 wt. % BWOC of the one or more additives, or from 0.1 to 3 wt. % BWOC of the one or more additives. The cement slurry may contain from 1 to 10 wt. % BWOC of the one or more additives, from 1 to 8 wt. % BWOC, from 1 to 5 wt. % BWOC, or from 1 to 3 wt. % BWOC of the one or more additives. In some embodiments, the cement slurry may contain from 3 to 5 wt. % BWOC, from 3 to 8 wt. % BWOC, from 3 to 10 wt. % BWOC, or from 5 to 10 wt. % BWOC of the one or more additives.

In some embodiments, the one or more additives may include a dispersant containing one or more anionic groups. the dispersant may include synthetic sulfonated polymers, lignosulfonates with carboxylate groups, organic acids, hydroxylated sugars, or combinations of any of these. Without being bound by any particular theory, in some embodiments, the anionic groups on the dispersant may be adsorbed on the surface of the cement particles to impart a negative charge to the cement slurry. The electrostatic repulsion of the negatively charged cement particles may allow the cement slurry to be dispersed and more fluid-like, improving flowability. This may allow for one or more of turbulence at lesser pump rates, reduction of friction pressure when pumping, reduction of water content, and improvement of the performance of fluid loss additives.

In some embodiments, the one or more additives may alternatively or additionally include a fluid loss additive. In some embodiments, the cement fluid loss additive may include non-ionic cellulose derivatives. In some embodiments, the cement fluid loss additive may be hydroxyethylcellulose (HEC). In other embodiments, the fluid loss additive may be a non-ionic synthetic polymer (for example, polyvinyl alcohol or polyethyleneimine). In some embodiments, the fluid loss additive may include bentonite, which may additionally viscosify the cement slurry and may, in some embodiments, cause additional retardation effects.

In some embodiments, the cement slurry may contain from 0.1 wt. % BWOC to 10 wt. % BWOC of one or more fluid loss additives, the one or more dispersants, or both. The cement slurry may contain from 0.02 to 90 pounds per barrel (lb/bbl) of the fluid loss additives, the one or more dispersants, or both based on the total weight of the cement slurry. For instance, the cement slurry may contain from 0.1 to 90 lb/bbl, from 0.1 to 75 lb/bbl, from 0.1 to 50 lb/bbl, from 1 to 90 lb/bbl, from 1 to 50 lb/bbl, from 5 to 90 lb/bbl, or from 5 to 50 lb/bbl of the fluid loss additives, the one or more dispersants, or both.

The cement slurry may have a thickening time at 400° F. of from 1 to 100 hours, 1 to 70 hours, 1 to 65 hours, 1 to 60 hours, 1 to 40 hours, 1 to 20 hours, 1 to 15 hours, 1 to 10 hours, 1 to 5 hours, 1 to 4 hours, 1 to 2 hours, 2 to 100 hours, 2 to 70 hours, 2 to 65 hours, 2 to 60 hours, 2 to 40 hours, 2 to 20 hours, 2 to 15 hours, 2 to 10 hours, 2 to 5 hours, 2 to 4 hours, 4 to 100 hours, 4 to 70 hours, 4 to 65 hours, 4 to 60 hours, 4 to 40 hours, 4 to 20 hours, 4 to 15 hours, 4 to 10 hours, 4 to 5 hours, 5 to 100 hours, 5 to 70 hours, 5 to 65 hours, 5 to 60 hours, 5 to 40 hours, 5 to 20 hours, 5 to 15 hours, 5 to 10 hours, 10 to 100 hours, 10 to 70 hours, 10 to 65 hours, 10 to 40 hours, 10 to 20 hours, 10 to 15 hours, 15 to 100 hours, 15 to 70 hours, 15 to 65 hours, 15 to 60 hours, 15 to 40 hours, 15 to 20 hours, 20 to 100 hours, 20 to 70 hours, 20 to 65 hours, 20 to 40 hours, 40 to 100 hours, 40 to 70 hours, 40 to 65 hours, 40 to 60 hours, 60 to 100 hours, 60 to 70 hours, 60 to 65 hours, 65 to 100 hours, 65 to 70 hours, or 70 to 100 hours.

A thickening time test is used to simulate pumping conditions in order to determine a length of time before the cement becomes difficult or impossible to pump. The most common method to determine thickening time is via a pressurized consistometer. This device allows pressure and temperature to be applied to a cement slurry while it is being stirred (typically at 150 revolutions per minute (RPM)). A resistor arm on a potentiometer indicates resistance to the paddle turning as the cement sets. The apparatus is calibrated to a standard output in Bearden Consistency units. The device is fully automated and can simulate squeeze schedules or batch mixing, and may have variable speed motors for use in the dynamic settling test.

Embodiments of the disclosure also relate to methods of producing the cement slurries previously described. In some embodiments, the method for producing a cement slurry may include mixing water with a cement precursor material, acrylic acid copolymer, zinc oxide, and a phosphonic acid-based thickener to produce a cement slurry. The water, cement precursor material, acrylic acid copolymer, zinc oxide, and a phosphonic acid-based thickener may be in accordance with any of the embodiments previously described. The cement slurry may include one or more additives, including but not limited to DTPMP, dispersants, and fluid loss additives. The mixing step, in some embodiments, may involve shearing the water, cement precursor material, acrylic acid copolymer, zinc oxide, and, optionally, other additives at a suitable speed for a suitable period of time to form the cement slurry. In one embodiment, the mixing may be done in the lab using a standard API blender for 15 seconds at 4,000 RPM and 35 seconds at 12,000 RPM. The equation of mixing energy is:

$$\frac{E}{M} = \frac{k {ω}^{2} t}{V} \qquad EQUATION 1$$

where
E=Mixing energy (kJ)
M=Mass of slurry (kg)
k=6.1×10⁻⁸ m⁵/s (constant found experimentally)
ω=Rotational speed (radians/s)
t=Mixing time (s)
V=Slurry volume (m³)

Further embodiments of the present disclosure relate to methods of using the cement slurries previously described. In some embodiments, the method may include pumping the cement slurry into a location to be cemented and curing the cement slurry by allowing the water and the cement precursor material to react. The location to be cemented may, for instance, be a well, a wellbore, an annulus, or other such locations.

Cementing is performed when the cement slurry is deployed into the well via pumps, displacing the drilling fluids located within the well, and replacing them with cement. The cement slurry flows to the bottom of the wellbore through the casing, which will eventually be the pipe through which the hydrocarbons flow to the surface. From there, the cement slurry fills in the space between the casing and the wellbore wall, and hardens. This creates a seal so that outside materials cannot enter the well flow, as well as permanently positions the casing in place. In preparing a well for cementing, it is important to establish the amount of cement required for the job. This may be done by measuring the diameter of the borehole along its depth, using a caliper log. Utilizing both mechanical and sonic means, multi-finger caliper logs measure the diameter of the well at numerous locations simultaneously in order to accommodate for irregularities in the wellbore diameter and determine the volume of the openhole. Additionally, the required physical properties of the cement are essential before commencing cementing operations. The proper set cement is also determined, including the density and viscosity of the material, before actually pumping the cement into the hole.

In some embodiments, curing the cement slurry may refer to passively allowing time to pass under suitable conditions upon which the cement slurry may harden or cure through allowing one or more reactions between the water and the cement precursor material. Suitable conditions may be any time, temperature, pressure, humidity, and other appropriate conditions known in the cement industry to cure a cement composition. In some embodiments, suitable curing conditions may be ambient conditions. Curing may also involve actively hardening or curing the cement slurry by, for instance, introducing a curing agent to the cement slurry, providing heat or air to the cement slurry, manipulating the environmental conditions of the cement slurry to facilitate reactions between the water and the cement precursor, a combination of these, or other such means. Usually, the cement will be cured and convert from slurry to solid due to subsurface formation conditions, temperature, and pressure. In the laboratory, a curing chamber capable of applying temperature and pressure is used for curing the cement specimens at required conditions. Cubical molds (2″×2″×2″) and cylindrical cells (1.4″ diameter and 12″ length) were lowered into the curing chamber. Pressures and temperatures were maintained until shortly before the end of the curing where they were reduced to ambient conditions.

In some embodiments, curing may occur at a relative humidity of greater than or equal to 80% in the cement slurry and a temperature of greater than or equal to 50° F. for a time period of from 1 to 14 days. Curing may occur at a relative humidity of from 80% to 100%, such as from 85% to 100%, or 90% to 100%, or from 95% to 100% relative humidity in the cement slurry. The cement slurry may be cured at temperatures of greater than or equal to 50° F., such as greater than or equal to 75° F., greater than or equal to 80° F., greater than or equal to 100° F., or greater than or equal to 120° F. The cement slurry may be cured at temperatures of from 50° F. to 250° F., or from 50° F. to 200° F., or from 50° F. to 150° F., or from 50° F. to 120° F. In some instances, the temperature may be as great as 500° F. The cement slurry may be cured for from 1 day to 14 days, such as from 3 to 14 days, or from 5 to 14 days, or from 7 to 14 days, or from 1 to 3 days, or from 3 to 7 days.

Further embodiments of the present disclosure relate to particular methods of cementing a casing in a wellbore. The method may include pumping a cement slurry into an annulus between a casing and a wellbore and curing the cement slurry. The cement slurry may be in accordance with any of the embodiments previously described. Likewise, curing the cement slurry may be in accordance with any of the embodiments previously described. As stated previously, cementing is performed when the cement slurry is deployed into the well via pumps, displacing the drilling fluids located within the well, and replacing them with cement. The cement slurry flows to the bottom of the wellbore through the casing, which will eventually be the pipe through which the hydrocarbons flow to the surface. From there it fills in the space between the casing and the actual wellbore, and hardens. This creates a seal so that outside materials cannot enter the well flow, as well as permanently positions the casing in place.

Embodiments of the disclosure also relate to methods of producing cured cements. The method may include combining water with a cement precursor material, acrylic acid copolymer, zinc oxide, and a phosphonic acid-based thickener. The cement slurry may be in accordance with any of the embodiments previously described. The method may include curing the cement slurry by allowing for a reaction between the water and the cement precursor material to produce cured cement. The curing step may be in accordance with any of the embodiments previously described.

In some embodiments, cement is composed of four main components: tricalcium silicate (Ca₃O₅Si) which contributes to the early strength development; dicalcium silicate (Ca₂SiO₄), which contributes to the final strength, tricalcium aluminate (Ca₃Al₂O₆), which contributes to the early strength; and tetracalcium alumina ferrite. These phases are sometimes called alite and belite respectively. In addition, gypsum may be added to control the reactivity of tricalcium aluminate.

In one embodiment, the silicates phase in cement may be about 75-80 wt. % of the total material. Ca₃O₅Si is the major constituent, with concentration ranging from 60-65 wt. %. The quantity of Ca₂SiO₄ conventionally does not exceed 20 wt. %, 30 wt. % or 40 wt. %. The hydration products for Ca₃O₅Si and Ca₂SiO₄ are calcium silicate hydrate (Ca₂H₂O₅Si) and calcium hydroxide (Ca(OH)₂), also known as Portlandite. The calcium silicate hydrate, commonly called CSH gel, has a variable C:S and H:S ratio depending on the temperature, calcium concentration in the aqueous phase, and the curing time. The CSH gel comprises +/−70 wt. % of fully hydrated Portland cement at ambient conditions and is considered the principal binder of hardened cement. Upon contact with water, the gypsum may partially dissolves releasing calcium and sulphate ions to react with the aluminate and hydroxyl ions to form a calcium trisulphoaluminate hydrate, known as the mineral ettringite (Ca₆Al₂(SO₄)₃(O₁)₁₂.26H₂O) that will precipitate onto the Ca₃O₅Si surfaces preventing further rapid hydration (flash-set). The gypsum is gradually consumed and ettringite continues to precipitate until the gypsum is consumed. The sulphates ion concentration will be drop down and the ettringite will become unstable converting to calcium monosulphoaluminate hydrate (Ca₄Al₂O₆(SO₄).14H₂O). The remaining unhydrated Ca₃O₅Si will form calcium aluminate hydrate. Cement slurry design is based on the altering or inhibition of the hydration reactions with specific additives.

The cured cement may include one or more of calcium hydroxide, silicates, oxides, belite (Ca₂SiO₅), alite (Ca₃SiO₄), tricalcium aluminate (Ca₃Al₂O₆), tetracalcium aluminoferrite (Ca₄Al₂Fe₂O₁₀), brownmilleriate (4CaO.Al₂O₃.Fe₂O₃), gypsum (CaSO₄.2H₂O) sodium oxide, potassium oxide, limestone, lime (calcium oxide), hexavalent chromium, calcium aluminate, other similar compounds, and combinations of these. The cement precursor material may include Portland cement, siliceous fly ash, calcareous fly ash, slag cement, silica fume, any known cement precursor material or combinations of any of these.

Without being bound by any particular theory, controlling the fluid loss and rheology properties of the cement slurry when producing the cured cement may result in a stronger, more stable cured cement, as previously discussed. In some embodiments, the cured cement of the present disclosure may have a compressive strength of from 400 to 5000 pounds per square inch (psi) in the compressive strength test conducted according to API recommended practice 10B-2. In the test, the set cement cubes were removed from the molds, and placed in a hydraulic press where increasing force was exerted on each cubes until failure. The hydraulic press system used in this study applied known compressive loads to the samples. This system was designed to test the compressive strength of sample cement cubes in compliance with API recommended practice 10B-2.

In some embodiments, the cement slurry may contain water and may be water-based. As such, the cement slurry may by hydrophilic, forming stronger bonds with water-wet surfaces. Well sections drilled with non-aqueous drilling fluids may have oil-wet surfaces, resulting in poor bonding between the well and the cement slurry, as oil and water are not miscible. Poor bonding may lead to failed isolation and a buildup of unwanted casing-casing or tubing-casing annular pressure. Without being bound by theory, it is desirable to make the subsurface formation or casing water wet to enhance and improve the bonding between cement and casing and cement and subsurface formation. If the wettability of the subsurface formation or casing is oil wet not water wet then the bonding will fail and could result in small gap(s) or channel(s) between the cement and casing or the cement and subsurface formation thereby resulting in improper wellbore isolation. This improper wellbore isolation could lead to fluid or gas escaping from the well through this gas or channel.

As a non-limiting example, to perform a wettability test, casing coupons used in the test may be a piece of metal taken as a sample from the tubulars that will be cemented downhole. A piece of tape may be placed down the center of the casing coupon to provide a standard for a complete oil-wet surface. To the left of the tape strip, the casing metal coupon is present while the side to the right of the tape is left unwashed. The washing is performed using surfactant. The side of casing coupon is washed in a viscometer cup filled with the specified surfactant solution. The viscometer is rotated at 100 RPM for 30 minutes and at a temperature of 140° F. A water droplet may be placed in each of the three sections. The droplet may be visually observed after a period of time, after undergoing a variety of conditions, or after a combination of both to determine the wettability. The same test procedure may be performed with a piece of cured cement composition in place of the casing coupon metal.

The droplet on the Teflon surface may not absorb into the cement but rather may maintain a contact angle with the test surface of from 120° to 1800. The droplet on the Teflon surface should consistently display poor wettability and can be used as a control sample. To the left and right of the Teflon strip, the water droplet may completely absorb into the cement, partially absorb into the cement, may spread out onto the cured cement, or may maintain its spherical droplet nature based on how water-wet the cement is. In some embodiments, a droplet having a contact angle of greater than 90° may be considered cement having poor water wettability. A droplet having a contact angle of less than 90° but greater than or equal to 350 may be considered cement having fair wettability. Finally, if the droplet has a contact angle of less than 350, the cement may have good wettability. Water wettability may be inversely related to oil wettability. That is, if a water droplet is repelled by the cement, it may be an indication that the cement is hydrophobic and may have good oil-wettability, or an affinity for oil.

As mentioned, the droplet may be observed under a variety of conditions. In some embodiments, the wettability of the cured cement, or the wettability of the casing coupon may be observed after preheating the cement for 30 minutes at a temperature of 140° F. Likewise, the cement may be immersed in an oil based mud for 10 minutes and the wettability may be observed. In some embodiments, the cement may be attached to a rotor or a viscometer cup and may be immersed in a spacer fluid such that at least about two thirds of the cement is immersed in the fluid. The cement is immersed while being attached to a side of viscometer cup to insure it remains static while the fluid is being stirred by the viscometer rotation The cement may be rotated at 100 rotations per minute (RPMs) for 30 minutes and the wettability determined. The intention of dipping the sample in oil based mud is to insure that the sample is “oil-wet”. Oil wet samples will show a specific contact angle with water (<900). After that, the same sample may dipped in surfactant to try and convert it to being “water-wet”. Water wet samples will show a different contact angle (>90°). If the surfactant is successful, it will be able to convert the sample into being a water-wet and this will be shown from the contact angle variations.

### Examples

A basic slurry was formed having a composition as shown in Table 1. Saudi Class G cement includes from 60% to 100% Portland cement and less than 3% crystalline silica.

TABLE 1
Basic Slurry Composition

| Component | Amount (g) | Concentration (BWOC) |
|---|---|---|
| Saudi Class G Cement | 785 | |
| Silica Flour | 275.5 | 35 wt. % |
| Hydroxyethyl Cellulose | 1.48 | 0.2 wt. % |
| Water | 520 | |

Using the slurry composition from Table 1 as a base composition, various slurry samples were formed by adding retarders, as detailed in Table 2. These various samples were then tested for thickening time and its compressive strength development over time while it is being cured under downhole temperature and pressure conditions. This compressive strength development was measured using a Chandler 4265-HT ultrasonic cement analyzer (UCA) according to API recommended practice 10B-2.

TABLE 2
Thickening Times (TT) and Ultrasonic Cement Analysis (UCA) at 400° F. for
inventive and comparative slurry compositions including the basic slurry composition in
Table 1 and PCR-3 acrylic acid copolymer and zinc oxide.

| | Retarder | | Retarder | | Retarder | | TT | UCA |
|---|---|---|---|---|---|---|---|---|
| Sample # | 1 | % bwoc | 2 | % bwoc | 3 | % bwoc | (hr) | (hr) |
| Inventive | Dequest ® | 0 | PCR-3 | 0.94 | Zinc | 0.30 | 4 | 4.5 |
| Sample 1 | 2066 | | | | Oxide | | | |
| Comparative | Dequest ® | 0 | PCR-3 | 0.94 | Zinc | 0 | 1.2 | 2.0 |
| Sample 1 | 2066 | | | | Oxide | | | |
| Comparative | Dequest ® | 0 | PCR-3 | 0 | Zinc | 0.3 | 1.0 | 1.5 |
| Sample 2 | 2066 | | | | Oxide | | | |

TABLE 3
Thickening Times (TT) and Ultrasonic Cement Analysis (UCA) at 400° F. for
inventive slurry compositions including the basic slurry composition in Table 1 and PCR-3
acrylic acid copolymer, zinc oxide and Dequest ® 2066 DTPMP.

| | Retarder | | Retarder | | Retarder | | TT | UCA |
|---|---|---|---|---|---|---|---|---|
| Sample # | 1 | % bwoc | 2 | % bwoc | 3 | % bwoc | (hr) | (hr) |
| Inventive | Dequest ® | 0.94 | PCR-3 | 0.94 | Zinc | 0.30 | 18.25 | 19.75 |
| Sample 2 | 2066 | | | | Oxide | | | |
| Inventive | Dequest ® | 0.94 | PCR-3 | 0.94 | Zinc | 0 | 5.2 | 8.9 |
| Sample 3 | 2066 | | | | Oxide | | | |
| Inventive | Dequest ® | 0.94 | PCR-3 | 0.47 | Zinc | 0.30 | 61.4 | 25 |
| Sample 4 | 2066 | | | | Oxide | | | |

Dequest 2066 is an organophosphonate. Specifically, it comprises diethylenepentaamine methylenephosphonic acid and water. The zinc oxide was J.T. Baker® BAKER ANALYZED™ A.C.S. Reagent Acid, available from Avantor®. PCR-3, available from Fritz Industries, is an 2-acrylamido-2-methylpropane sulfonic acid copolymer retarder with a molecular weight of 207 g/mol useful in applications with bottom hole circulating temperatures up to 250° F. in fresh water slurries.

As shown in Table 2, Inventive Sample 1, which contained PCR-3 acrylic acid copolymer and zinc oxide, showed an extended thickening time and compressive strength as compared to Comparative Samples 1 and 2. Specifically, Inventive Sample 1 showed a thickening time of greater than 3 times the thickening times of both Comparative Samples 1 and 2. Having a longer thickening time may allow the cement slurry to be more easily and more precisely positioned, for instance, in an oil or gas well. When a cement slurry gels it may become quite difficult to handle and place the slurry, which may be rendered unpumpable and may be difficult to remove.

As shown in Table 3, Inventive Samples 2 and 4 contained varying amounts of PCR-3 acrylic acid copolymer, zinc oxide, and Dequest® 2066 DTPMP. Inventive Sample 3, which contained PCR-3 acrylic acid copolymer and Dequest® 2066 DTPMP, but did not contain zinc oxide, showed a lesser thickening time than Inventive Samples 2 and 4. Inventive Sample 4 showed the unexpected results of a greater thickening time than Inventive Sample 2, even though Inventive Sample 4 contained only half the amount of PCR-3 acrylic acid copolymer present in Inventive Sample 2.

The following description of the embodiments is illustrative in nature and is in no way intended to be limiting it its application or use. As used throughout this disclosure, the singular forms “a,” “an” and “the” include plural referents unless the context clearly dictates otherwise. Thus, for example, reference to “a” component includes aspects having two or more such components, unless the context clearly indicates otherwise.

It should be apparent to those skilled in the art that various modifications and variations may be made to the embodiments described within without departing from the spirit and scope of the claimed subject matter. Thus, it is intended that the specification cover the modifications and variations of the various embodiments described within provided such modification and variations come within the scope of the appended claims and their equivalents.

It is noted that one or more of the following claims utilize the term “in which” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

Having described the subject matter of the present disclosure in detail and by reference to specific embodiments of any of these, it is noted that the various details disclosed within should not be taken to imply that these details relate to elements that are essential components of the various embodiments described within, even in cases where a particular element is illustrated in each of the drawings that accompany the present description. Further, it should be apparent that modifications and variations are possible without departing from the scope of the present disclosure, including, but not limited to, embodiments defined in the appended claims. More specifically, although some aspects of the present disclosure are identified as particularly advantageous, it is contemplated that the present disclosure is not necessarily limited to these aspects.

The presently described subject matter may include one or more aspects, which should not be regarded as limiting on the teachings of the present disclosure. A first aspect may include cement slurry comprising: water; a cement precursor material; acrylic acid copolymer; zinc oxide; and a phosphonic acid-based thickener.

A second aspect may include a method of cementing a wellbore, comprising: pumping a cement slurry comprising water, a cement precursor material, acrylic acid copolymer, zinc oxide, and a phosphonic acid-based thickener into a location to be cemented; and curing the cement slurry by allowing the water and the cement precursor material to react.

A third aspect may include any previous aspect, in which the phosphonic acid-based thickener comprises at least one of diethylenetriamine pentamethylphosphonic acid (DTPMP) or nitrilotris(methylene) triphosphonic acid (NTMP).

A fourth aspect may include any previous aspect, in which the cement slurry has a thickening time at 400° F. of greater than 4 hours and less than 65 hours.

A fifth aspect may include any previous aspect, in which the cement slurry comprises from 0.4 to 2 wt. % by weight of cement precursor (BWOC) DTPMP.

A sixth aspect may include any previous aspect, in which the cement slurry comprises from 0.4 to 2 wt. % BWOC acrylic acid copolymer.

A seventh aspect may include any previous aspect, in which the cement slurry comprises from 0.4 to 2 wt. % BWOC acrylic acid copolymer.

An eighth aspect may include any previous aspect, in which the cement slurry comprises from 0.1 to 1 wt. % BWOC zinc oxide.

A ninth aspect may include any previous aspect, in which the acrylic acid copolymer comprises 2-acrylamido-2-methylpropane sulfonic acid.

A tenth aspect may include any previous aspect, in which the cement slurry has a thickening time at 400° F. of greater than 2 hours and less than 65 hours.

An eleventh aspect may include any previous aspect, in which the cement precursor material is a hydraulic cement precursor.

A twelfth aspect may include any previous aspect, in which the cement precursor material comprises one or more components selected from the group consisting of calcium hydroxide, silicates, belite (Ca₂SiO₅), alite (Ca₃SiO₄), tricalcium aluminate (Ca₃Al₂O₆), tetracalcium aluminoferrite (Ca₄Al₂Fe₂O₁₀), brownmilleriate (4CaO.Al₂O₃.Fe₂O₃), gypsum (CaSO₄.2H₂O) sodium oxide, potassium oxide, limestone, lime (calcium oxide), hexavalent chromium, calcium aluminate, quartz, and combinations thereof.

A thirteenth aspect may include any previous aspect, in which the cement precursor material comprises Portland cement precursor, siliceous fly ash, calcareous fly ash, slag cement, silica fume, quartz, or combinations thereof.

A fourteenth aspect may include any previous aspect, in which the cement precursor material comprises Saudi cement precursor.

A fifteenth aspect may include any previous aspect, in which the cement slurry further comprises silica flour.

What is claimed is:

1. A cement slurry comprising:
water;
a cement precursor material;
acrylic acid copolymer;
zinc oxide; and
a phosphonic acid-based thickener.

2. The cement slurry of claim 1, in which the phosphonic acid-based thickener comprises at least one of diethylenetriamine pentamethylphosphonic acid (DTPMP) or nitrilotris(methylene) triphosphonic acid (NTMP).

3. The cement slurry of claim 2, in which the cement slurry has a thickening time at 400° F. of greater than 4 hours and less than 65 hours.

4. The cement slurry of claim 2, in which the cement slurry comprises from 0.4 to 2 wt. % by weight of cement precursor (BWOC) DTPMP.

5. The cement slurry of claim 1, in which the cement slurry comprises from 0.4 to 2 wt. % BWOC acrylic acid copolymer.

6. The cement slurry of claim 1, in which the cement slurry comprises from 0.1 to 1 wt. % BWOC zinc oxide.

7. The cement slurry of claim 1, in which the acrylic acid copolymer comprises 2-acrylamido-2-methylpropane sulfonic acid.

8. The cement slurry of claim 1, in which the cement slurry has a thickening time at 400° F. of greater than 2 hours and less than 65 hours.

9. The cement slurry of claim 1, in which the cement precursor material is a hydraulic cement precursor.

10. The cement slurry of claim 1, in which the cement precursor material comprises one or more components selected from the group consisting of calcium hydroxide, silicates, belite (Ca₂SiO₅), alite (Ca₃SiO₄), tricalcium aluminate (Ca₃Al₂O₆), tetracalcium aluminoferrite (Ca₄Al₂Fe₂O₁₀), brownmilleriate (4CaO.Al₂O₃Fe₂O₃), gypsum (CaSO₄.2H₂O) sodium oxide, potassium oxide, limestone, lime (calcium oxide), hexavalent chromium, calcium aluminate, quartz, and combinations thereof.

11. The cement slurry of claim 1, in which the cement precursor material comprises Portland cement precursor, siliceous fly ash, calcareous fly ash, slag cement, silica fume, quartz, or combinations thereof.

12. The cement slurry of claim 1, in which the cement precursor material comprises Saudi cement precursor.

13. The cement slurry of claim 1, in which the cement slurry further comprises silica flour.

14. A method of cementing a wellbore, comprising:
pumping a cement slurry comprising water, a cement precursor material, acrylic acid copolymer, zinc oxide, and a phosphonic acid-based thickener into a location to be cemented; and
curing the cement slurry by allowing the water and the cement precursor material to react.

15. The method of claim 14, in which the phosphonic acid-based thickener comprises at least one of diethylenetriamine pentamethylphosphonic acid (DTPMP) or nitrilotris(methylene) triphosphonic acid (NTMP).

16. The method of claim 14, in which the cement slurry has a thickening time at 400° F. of greater than 4 hours and less than 60 hours.

17. The method of claim 14, in which the cement slurry comprises from 0.4 to 2 wt. % by weight of cement precursor (BWOC) DTPMP.

18. The method of claim 14, in which the cement slurry comprises from 0.4 to 2 wt. % BWOC acrylic acid copolymer.

19. The method of claim 14, in which the cement slurry comprises from 0.1 to 1 wt. % BWOC zinc oxide.

20. The method of claim 14, in which the acrylic acid copolymer comprises 2-acrylamido-2-methylpropane sulfonic acid.
